(19) United States
(12) Patent Application Publication
(10) Pub. No.: US 2014/0182062 A1
(43) Pub. Date: Jul. 3, 2014

(54) Safe Lateral Decubitus Positioning Apparatus

(71) Applicant: Mehran S. Aghazadeh, Newton, MA (US)

(72) Inventor: Mehran S. Aghazadeh, Newton, MA (US)

(21) Appl. No.: 13/731,638

(22) Filed: Dec. 31, 2012

(51) Int. Cl. A61G 13/12

(52) U.S. Cl. CPC A61G 13/12
USPC 5/621

(57) ABSTRACT

The present invention provides a novel apparatus with unique methodology and system for safely, securely and comfortably placing patients in lateral decubitus position for operations without needing to lift the patient. It eliminates consequences of lifting that puts patient and operative team at risk of injury. It is very cost effective by saving hospitals and surgical centers' human and financial resources.

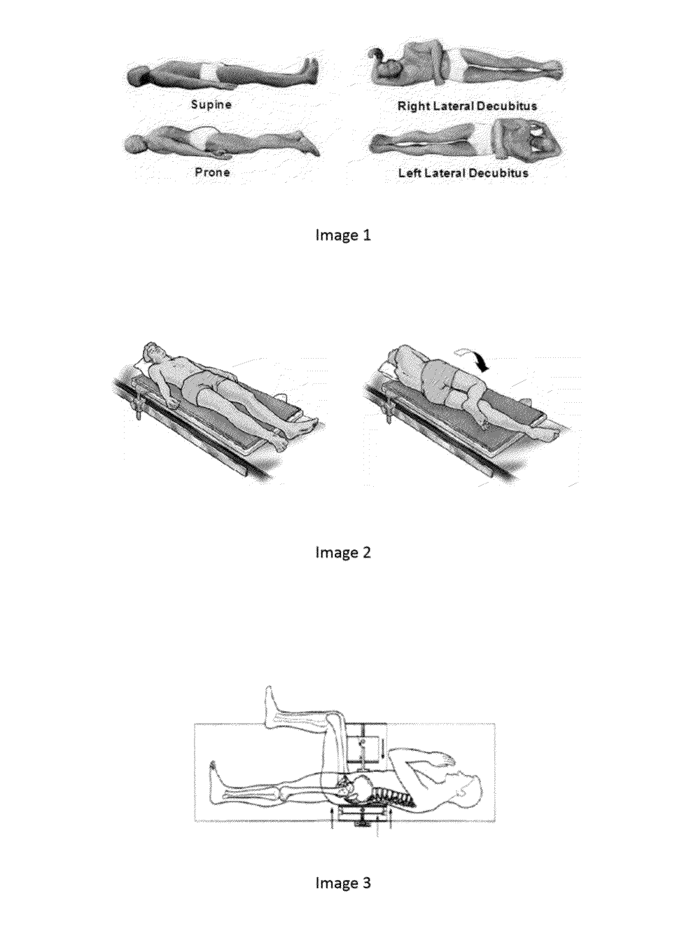

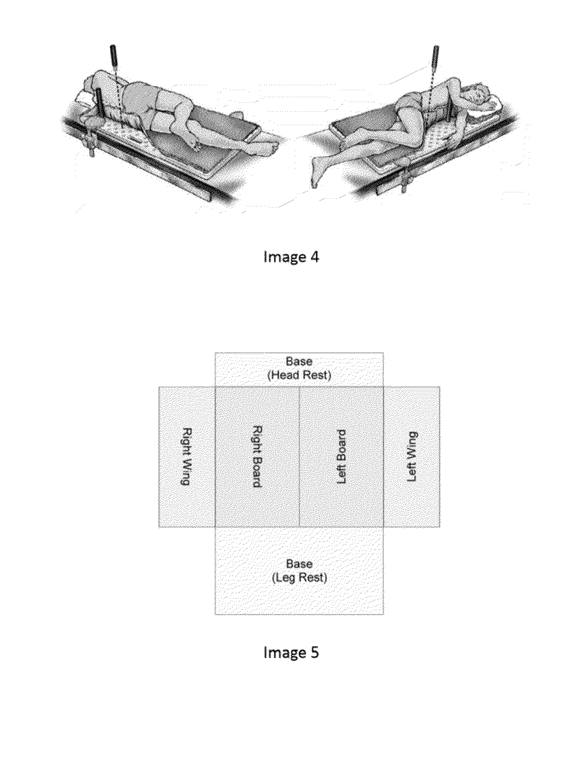

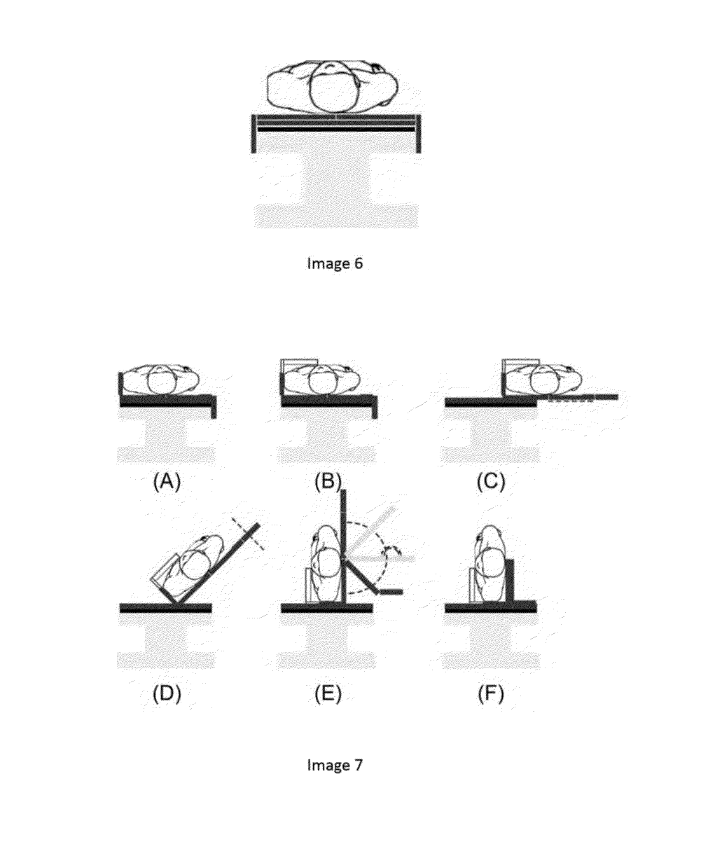

### BACKGROUND OF THE INVENTION

The safety and well-being of surgical patients are in the hands of the peri-operative team when they enter the operating room. Even as technology continues to advance, the one constant is that each patient must be properly positioned for the procedure. Positioning must be done correctly, safely and efficiently for all patients regardless of body habits, while maintaining body alignment and skin integrity and preventing injury. Inappropriate positioning may result in a more challenging procedure, even be hazardous for both the patient and the operating team.

Positioning involves mobilizing, stabilizing and securing the patient to provide the most optimal exposure of the surgical site This will allow the operation to be done without difficulty as well as with enough access for the anesthetist for administering anesthetic and other medications. Patients must remain in a stable position for the duration of the operation, while maintaining physiological functions and patient comfort.

The goals of proper patient positioning can be summarized as follows:
Optimal exposure and access to the surgical site
Access to intravenous sites and anesthesia support services
Support of circulatory and respiratory functions
Maintenance of proper anatomical body alignment
Protection of neuromuscular and skin integrity
Prevention of patient injury
Enhancement of patient comfort

Several positions have been developed for different procedures as shown in image 1:
Supine (face-up)
Lateral (on the side)
Prone (face-down)

Lateral and prone positions require lifting and turning the patient on their side and front, respectively. Supine does not require any lifting and rolling since patients remain on their back.

In the standard lateral decubitus position, the patient lies on one side. Typically, a 90° angle is established between the patient's back and the surface of the table. The lower leg is flexed in order to stabilize the torso against front tilt and the upper leg is extended.

The description of a lateral decubitus position always reflects the side of the patient that will rest against the surface of the table. For example, a patient in the left lateral decubitus position is positioned with the left side down, allowing access to the right side of the patient (image 1, right).

The lateral decubitus position has been most commonly used in Orthopaedic, Cardiothoracic, Neurosurgery, Urology, Plastic Surgery, General Surgery and Gynecology procedures.

Orthopaedic surgeons have used the lateral decubitus position extensively for total hip replacement, as well as for shoulder surgeries including rotator cuff repairs. Neurosurgeons may utilize the lateral decubitus position for craniotomies or for laminectomies at any level of the vertebral column.

### BRIEF DESCRIPTION OF IMAGES

Image 1) Top-Left; a patient in supine position, Top-Right; a patient in right lateral decubitus position, Bottom-Left; a patient in prone position, Bottom-Right; a patient in left lateral decubitus position

Image 2) Step 1 of lateral decubitus positioning

Image 3) A sample of holders

Image 4) Peg-board

Image 5) a basic drawing of parts of apparatus of this invention

Image 6) Drawing showing a patient in supine position over apparatus placed on operating table

Image 7) Steps A-F of positioning a patient using apparatus of this invention

### LATERAL DECUBITUS POSITIONING

The patient undergoes general or local anesthesia while lying down in supine position (image 2 left). Lateral decubitus positioning proceeds in two steps:

Step 1) Placing patient on one side

Patient is lifted or slid and pulled across the operating table, then turned and rolled to one side (image 2 right). Maintaining body, especially spinal alignment at all times is extremely important and needs strict attention. Patient must be lifted again to place an axillary roll under the upper body (just below the armpit). It is needed to support the upper rib cage area and to relieve pressure on the brachial plexus, axillary artery and nerve. Care must also be taken to avoid compression of the neurovascular structures in both femoral triangles.

Step 2: Securing patient on the operating table

After placement in the lateral decubitus position, the patient's body must be maintained in the same position throughout the entire operation. This ensures the appropriate identification of landmarks and avoids possible injuries.

### CURRENTLY AVAILABLE OPTIONS

A variety of positioning devices and accessories have been designed and are commercially available to the surgical team to aid in achieving the optimum surgical position and to provide safety and comfort for the patient. They provide different levels of stability to the laterally positioned patient.
Vacuum-style bean bag; is typically a sealed bag containing pellets made of synthetic material. After properly positioning the patient on the bean bag, the air is vacuumed out to provide a relatively rigid contour, simulating the body area in contact.
Holders and brackets; are attached to the operating table and placed against the bony prominences to stabilize the body in the same position (image 3).
Peg-board; is a rigid board with multiple holes that is placed over the operating table under the patient. Typically 4 rigid rods, known as pegs, are inserted into the holes closest to the patient's bony prominences in front and back to immobilize the body in the same position (image 4)

### RECURRENT CLINICAL AND OCCUPATIONAL PROBLEMS AND RISKS

Placement of a patient in lateral position requires three to five people in order to safely move and turn the patient. This number is dependent on the patient's body weight, and does not include the anesthesia provider who is responsible for immobilizing the head. Inadequate personnel and/or equipment can result in injury to patient and the peri-operative team as well.

Sliding and pulling the patient across stationary surfaces can result in shearing and/or friction.
Shearing refers to the patient's skin remaining stationary while underlying tissues shift or move. This might occur when the patient is pulled or dragged without support to the skeletal system or when a draw sheet is used.
Friction occurs when skin rubs over a rough stationary surface.

Maintaining the correct body alignment and supporting the extremities and joints decreases the potential for injury during transfer and positioning.

The peri-operative team is also at risk of occupational injuries to themselves by lifting a heavy object. It can range from muscle strains and spasms causing neck, shoulder and back pain to more serious injuries such as rotator cuff tear, disc herniation or inguinal hernias.

### WORDS AND TERMS

The following terms are frequently used in this document.
Position side (PS) is the side that patient is going to be positioned on. It is always the lower side that comes in contact with the operating table.
Operation Side (OS) is the side that the operation is going to be done on. It is always the upper side of the body, opposite to operation side.

### DESCRIPTION OF CURRENT INVENTION

The present invention includes a novel apparatus, as well as a unique methodology and system for safely moving and rotating the patient and securely and comfortably positioning and immobilizing him/her on the operating table without any need of lifting the patient. It can also be used in transferring the patient to bed from the operating table at the end of the procedure. It provides a unique solution particularly with respect to avoiding any skin and body damage to patient and occupational hazard to the operating team.

### COMPONENTS OF THE INVENTION

The apparatus of this novel lateral positioning system is designed in different configurations. In one embodiment it comprises of four major parts:
1. Base is attached to the operating table using special clamps and provides a stable platform for the mobile unit (image 5).
2. Mobile Unit is typically made of four sections (image 5):
   a. Right and Left Board in the middle
   b. Right and Left Wing on sides
3. Supporting Rods are attached to the wing on the position side and keep the patient immobilized in lateral decubitus position.
4. Supporting Pads cover the entire surface of the device that comes in contact with patient's body. It provides a soft cushion to evenly distribute the pressure and prevent damage particularly to the skin.

In another embodiment a front board is attached to the wing on the position side for anterior immobilization.

In another embodiment the mobile unit is built in the operating table. The operating table functions as a platform for the device.

In another embodiment parts of the mobile unit are moved by the motors built in the operating table and positioning is done using the electric power.

In another embodiment tensioning brackets are attached to the base and make the device useable for arthroscopy procedures as well.

In another embodiment each board is designed in two sections to accommodate short, average and tall patients.

In another embodiment the device is made in a standard and longer size to accommodate average and tall patients.

In another embodiment extension attachments are connected to wing and board to accommodate patients with larger body size.

### LATERAL DECUBITUS POSITIONING USING THE PRESENT INVENTION

The methodology comprising the present invention is summarized in performing the following two steps:

Step 1) Setting up the device

The apparatus is placed on the operating table and secured by special clamps, before bringing the patient into the operating room. When in the operating room, the patient lays down on the operating table over the lateral positioning board in usual fashion (image 6).

Step 2) Positioning the Patient

After induction of the anesthesia and while patient is lying down on back on the operating table:
A. The position side (PS) Wing (left in this example) is rotated 180° to side of the patient. It automatically locks in this position by the locking hinge, connecting it to PS-Board (image 7A).
B. Supporting rods are attached to the PS-Wing above the bony prominences of patient's body and locked (image 7B).
C. The operation side (OS) Wing is brought to horizontal level in line with the boards then the entire mobile unit with patient is moved over the base toward the operation side (image 7C).
D. Two Boards and the OS-Wing are used as a lever to lift and rotate the patient 90° to lateral decubitus position (image 7D). PS-Wing and the Supporting Rods are keeping the patient in place and prevent him/her from fall.
E. At this point, the PS-Wing is horizontal under patient, the other three mobile parts are in vertical position, and the patient is lying down on the position side. Keeping the PS-Board in vertical position, the OS-Board and OS-Wing are rotated 90° down as one unit around the middle hinge to horizontal position. The OS-Board is rotated another 90° down toward vertical position while the SS-Wing is kept horizontal (image 7E).
F. Now both wings are placed horizontally over the base and two boards are perpendicular to the base, parallel to each other supporting back of the patient (image 7F), The entire mobile unit is locked together. The final adjustment is done by moving the mobile unit forward or backward to the most desired position on the operating table. Then the mobile unit is locked on the base to a fixed position.

### MAJOR ADVANTAGES AND BENEFITS OF THE INVENTION

1. Positioning a patient in lateral decubitus without need to lift or slide the patient:
a. eliminates possible damages to patient's skin and body alignment
b. eliminates possible risks to operating team
c. decreases number of the people required for positioning
d. saves time required for positioning and OR time

2. Primary immobilization is done in supine position when evaluation of body alignment can be done more accurately. It also allows choosing the most proper spot for placing the supporting rods as well as the axillary roll. With Peg Board these are done when patient is in unstable lateral position and require additional lifting.

3. This device allows front-back adjustment of the patient's position using the mobile unit after turning patient on one side. Such and adjustment requires more lifting and sliding when using all of other positioning devices.

4. Supporting Rods are attached to the wing at any spot along the edge. It allows choosing the most proper spot adjacent to a bony prominence. The distance between two holes on peg board is about three inches in either direction. It happens very often that the proper location is between two possible positions on the peg board. It requires either lifting and repositioning the patient or more often choosing a less desirable spot.

5. It has one-piece support in back that distributes the pressure evenly along the back. It also allows adding extra cushion for more comfort. A common issue with peg beard is putting too much local pressure on the area where the pegs are placed. It can cause post-operative local discomfort for a while and in some cases chest pain and shortness of breath.

6. One-piece support board in the back provides more accurate lateral position that is important in a verity of procedures.

7. It is a multipurpose device and can be used for arthroplasties and arthroscopies as well other operations. The operators need to learn and work with only one device rather than two or more different devices.

8. It can be adjusted to accommodate patients with verity of body sizes and shapes.

9. This device is very easy to use and requires minimum training to operate.

10. It does not limit motion of the upper or lower limb and allows the orthopedic surgeon to easily test the range of motion of patient's joint when required during the operations.

11. This device can be made of radiolucent material that allows radiographic imaging when is needed during an operation.

12. It is very cost effective by lowering number of the people required for lateral positioning, saving operating time, eliminating risk of injury to patient and operating team and saving the positioning time.

I claim:

1. A system for use in lateral positioning a patient for performing procedures, without lifting or sliding patient's body.

2. In one embodiment the system of present invention is designed as a standalone apparatus.

3. In one embodiment the system of present invention is designed built-in current or newly designed standard or special operating tables.
